(19) United States
(12) Patent Application Publication
(10) Pub. No.: US 2010/0238093 A1
(43) Pub. Date: Sep. 23, 2010

(54) Method for Driving Electrophoretic Display Device

(76) Inventors: Qi-Ming Lu, Changhua County (TW); Hung-Hsiang Chen, Taoyuan County (TW); Jhen-Shen Liao, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/463,430

(22) Filed: May 11, 2009

(30) Foreign Application Priority Data
Mar. 18, 2009 (TW) 098108826

(51) Int. Cl. G09G 3/30

(52) U.S. Cl. 345/77

(57) ABSTRACT

An EPD device includes a plurality of pixels, wherein a first pixel is written by a first grey level, a second pixel is written by a second grey level. When the EPD device refreshes the displayed frame, the first pixel and the second pixel are erased individually. After the erasing of first pixel is completed, a third grey level is written to the first pixel immediately. After erasing of the second pixel is completed, a fourth grey level is written to the second pixel immediately. Thus, each pixel is written by their next grey levels immediately after the erasing step so the writing time is reduced and the motion blur of the EPD device when refreshing the displayed frame can be improved.

### BACKGROUND OF THE INVENTION

1. Field of the Invention

The present invention relates to a method for driving an Electrophoretic Display (EPD) device, and more particularly, to a method for driving an EPD device so as to improve the motion blur when the EPD device refreshes the displayed frames.

2. Description of the Prior Art

Paper is a commonly used display application, due to the advantages of its wide viewing angle, thin and flexible body, and easy-to-carry around characteristics. However, manufacturing paper consumes substantial natural resources and the message on the conventional paper is usually not updatable, or can only be updated for a limited number of times. Therefore, the Electrophoretic Display (EPD) device, also known as the electronic paper, is gaining popularity since the EPD device possesses the advantages of paper, as well as the updatable property of the electronic devices.

Please refer to FIG. 1. FIG. 1 is a diagram illustrating the conventional EPD device 100. The conventional EPD device 100 comprises a plurality of charged particles 101, an electrophoretic medium 102, an upper electrode 103, and a lower electrode 104. The upper electrode 103 and the lower electrode 104 are respectively located at the two ends of the electrophoretic medium 102. The upper electrode 103 is a transparent electrode and the lower electrode 104 is a segmented metal electrode. The charged particles 101, which carry positive charges, are suspended in the electrophoretic medium 102. The charged particles 101 are of a different color compare to the electrophoretic medium 102. The charged particles 101 are typically white Titanium Dioxide (TiO₂) particles, and the color of the electrophoretic medium 102 is black. The position of the charged particles 101 in the electrophoretic medium 102 is adjusted by applying an external driving voltage to the upper electrode 103 and the lower electrode 104, so as to display the color contrast between the charged particles 101 and the electrophoretic medium 102, for representing different grey levels of the displayed frame.

The different positions of the charged particles 101 in the electrophoretic medium 102 allow the EPD device 100 to display corresponding grey levels. As shown in FIG. 1, the charged particles 101 of the pixel P1 are in a position that is next to the upper electrode 103 of the electrophoretic medium 102, for the pixel P1 to display a white color. The charged particles 101 of the pixel P2 are in a position that is next to the lower electrode 104 in the electrophoretic medium 102, for the pixel P1 to display a black color. The charged particles 101 of the pixel P3 are in a middling position in the electrophoretic medium 102, for the pixel P3 to display a grey-level color. Therefore, the position of the charged particles 101 in the electrophoretic medium determines the grey level of the corresponding pixel. In other words, the EPD device operates in a reflective display mechanism and does not require a backlight source. The position of the charged particles 101 in the electrophoretic medium 102 is determined by the polarity and the pulse period of the driving voltage applied to the upper electrode 103 and the lower electrode 104. The polarity of the driving voltage determines the movement direction (i.e. the brightening or darkening of the grey level) of the charged particle 101 in the electrophoretic medium 102. For example, applying a positive driving voltage moves the charged particle 101 towards the upper electrode 103 so the grey level displayed transforms toward white; applying a negative driving voltage moves the charged particle 101 towards the lower electrode 104, so the grey level displayed transforms towards black. The pulse period of the driving voltage determines the distance of the movement (i.e. the degree of the grey level is varied) of the charged particle 101 in the electrophoretic medium 102.

Please refer to FIG. 1 and FIG. 2 together. FIG. 2 is a diagram illustrating the movement of the charged particles 101 when the driving voltage is applied. When the EPD device 100 starts to operate, an initialization is required to stimulate the inactive charged particles 101 of the pixel P1. The initialization phase is to apply a positive voltage V_{POS} followed by a negative voltage V_{NEG} for the charged particles 101 to move to an initialization position in the pixel P1. After the initialization phase is completed, the positive voltage V_{POS} is applied to the lower electrode 104 for the duration t_{G1}, for moving the charged particles 101 to a position corresponding to the grey level G1, so as to write the grey level G1 into the pixel P1. The pixel P1 needs to be erased before the next grey level G2 is written into the pixel P1. Typically, the time for the erasing step is approximately equivalent to the time for the previous writing step. Therefore, the negative voltage V_{NEG} is applied to the lower electrode 104 for the duration t_{G1}, for moving the charged particles 101 back to the initialization position. After the pixel P1 is erased, the positive voltage V_{POS} is applied to the lower electrode 104 for the duration t_{G2}, to write the grey level G2 into the pixel P1. Furthermore, after the grey-level data is written into the pixels, the charged particle 101 is able to retain the current position even without applying any driving voltage; this is the bi-stable characteristic of the EPD device. Therefore, the EPD device is able to keep the last displayed frame even after the power is turned off, and the EPD device consumes power only when the displayed frame is refreshed (i.e. applying the driving voltage for creating an electric field to move the charged particles to a different position).

Please refer to FIG. 3. FIG. 3 is a timing diagram illustrating the driving voltages of the conventional EPD device. The duration to represents the initialization time; the duration t_{WRITE} represents the time required for a pixel to complete the writing step; the duration t_{ERASE} represents the time required for a pixel to complete the erasing step; the duration t_{REFRESH} represents the time required to refresh an original displayed frame to be a new displayed frame. As shown in FIG. 3, the frame is displayed by the multiple pixels PX1˜PXm of the conventional EPD device, wherein the duration tₘ required for the pixel PXm represents the longest time for writing the grey level Gm into the pixel PXm. Therefore, the duration required for erasing the pixel PXm is also the same as the longest duration tₘ; due to the time for erasing is approximately equivalent to the time for writing. In other words, when the EPD device refreshes the display, other pixels must wait for the pixel PXm to complete erasing before the next grey level is proceeded to write. For that reason, the duration t_{ERASE} required for erasing all pixels is equivalent to the longest erase duration tₘ, consequently increasing the duration t_{REFRESH} required to refresh the displayed frame. When the time of which the EPD device takes to refresh the displayed frame is excessively elongated, motion blur spawns, and the display quality is deteriorated.

### SUMMARY OF THE INVENTION

The present invention provides a method for driving an Electrophoretic Display (EPD) device. The method comprises writing a first grey-level data to a first pixel; writing a second grey-level data to a second pixel; erasing the first pixel; erasing the second pixel; after the first pixel is erased, writing a third grey-level data to the first pixel immediately; and after the second pixel is erased, writing a fourth grey-level data to the second pixel immediately.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the conventional EPD device.

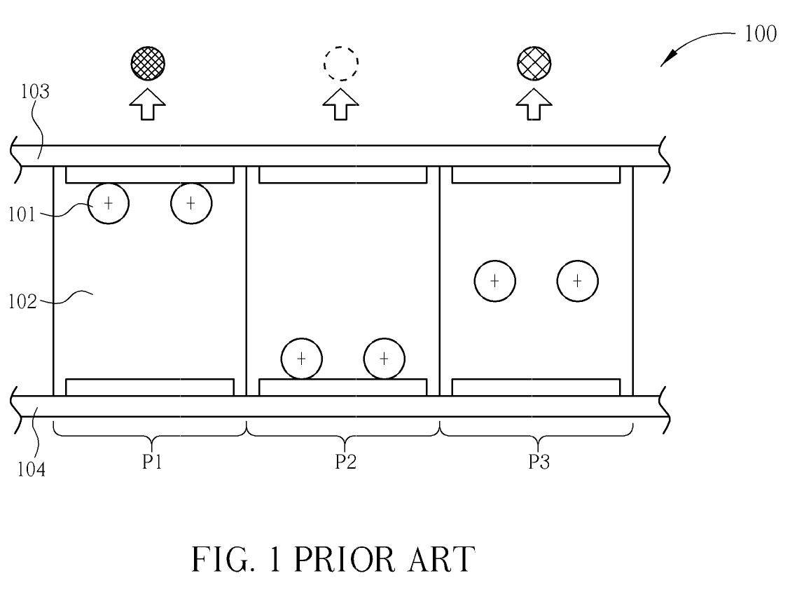

FIG. 2 is a diagram illustrating the movement of the charged particles when the driving voltage is applied.

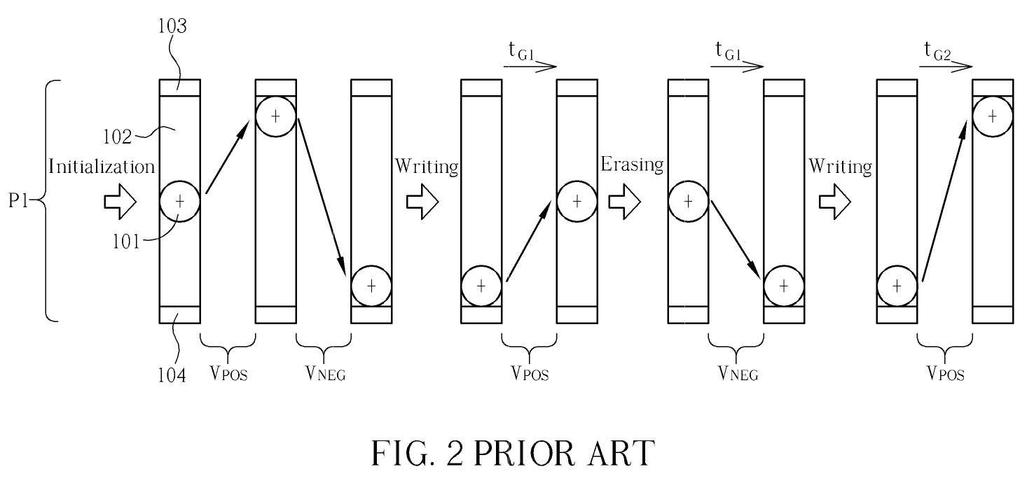

FIG. 3 is a timing diagram illustrating the driving voltages of the conventional EPD device.

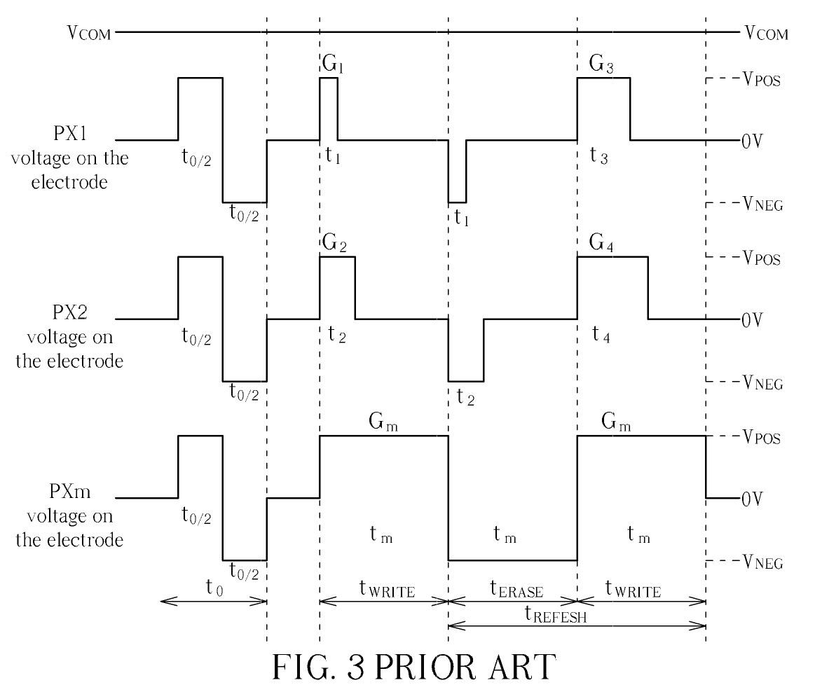

FIG. 4 is a diagram illustrating the EPD device of the present invention.

FIG. 5 is a diagram illustrating the relationship between the data D7˜D0 and the pixels PX1˜PX4.

FIG. 6 is a diagram illustrating the truth table of the driving voltage according to the different output combinations of the data D7˜D0.

FIG. 7 is a timing diagram illustrating the timing sequence of the data D7˜D0 outputted from the timing controller.

FIG. 8 is a timing diagram illustrating the driving voltages of the EPD device of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

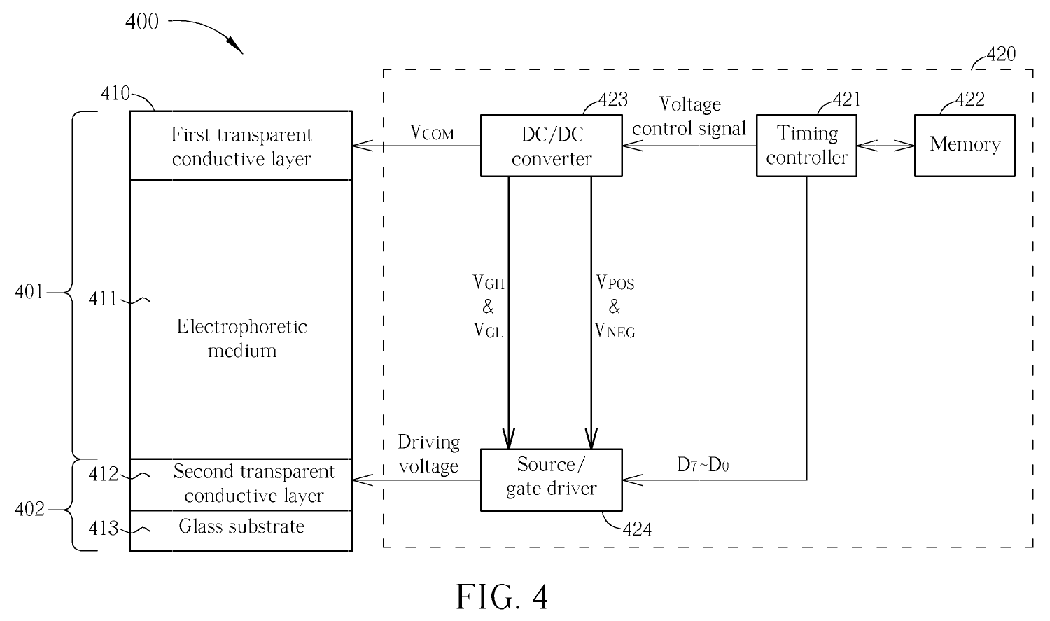

Please refer to FIG. 4. FIG. 4 is a diagram illustrating the EPD device 400 of the present invention. The EPD device 400 comprises an EPD substrate 401, a Thin Film Transistor (TFT) substrate 402, and a driving system 420. The EPD substrate 401 comprises a first transparent conductive layer 410 and an electrophoretic medium 411. The TFT substrate 402 comprises a second transparent conductive layer 41 2 and a glass substrate 41 3. The driving system 420 comprises a timing controller 421, a memory 422, a DC/DC converter 423, and a source/gate driver 424. The timing controller 421 supplies a voltage control signal to the DC/DC converter 423, as well as providing the data D7˜D0 to the source/gate driver 424. The memory 422 is electrically connected to the timing controller 421 for storing the writing data and the erasing data of every pixel. The DC/DC converter 423 is electrically connected to the timing controller 421, for generating the driving voltages V_{COM}, V_{GH}, V_{GL}, V_{POS}, and V_{NEG} according to the voltage control signal. The source/gate driver 424 is electrically connected to the timing controller 421 and the DC/DC converter 423, for outputting a driving voltage according to the data D7˜D0 and the driving voltages V_{COM}, V_{GH}, V_{GL}, V_{POS}, and V_{NEG}. The driving voltage is outputted from the source/gate driver 424 to the TFTs on glass substrate 413 to generate an electrical field via the second transparent conductive layer 412 for driving the charged particles to move in the electrophoretic medium 411.

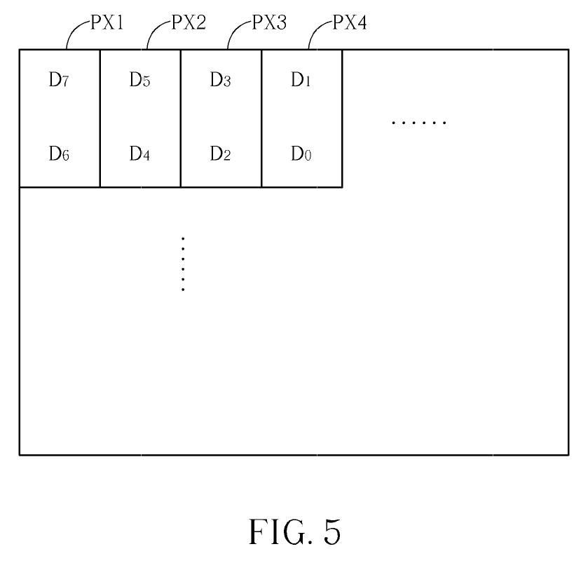

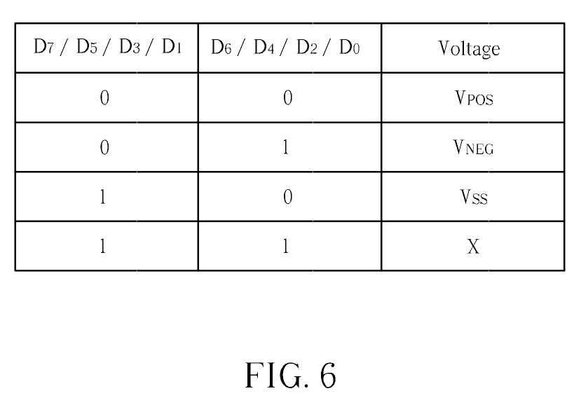

Please refer to FIG. 4, FIG. 5 and FIG. 6 together. FIG. 5 is a diagram illustrating the relation between the data D7˜D0 and the pixels PX1˜PX4. FIG. 6 is a diagram illustrating the truth table of the driving voltage according to the different output combinations of the data D7˜D0. As shown in FIG. 4, each of the data D7˜D0 comprises 8 bits. The source/gate driver 424 determines the driving voltage transmitted to the TFTs on the glass substrate 413 according to the received data D7˜D0. As shown in FIG. 5, the data D7˜D0 determines the driving voltage for controlling four pixels PX1˜PX4 of a displayed frame. For example, the data D7 and D6 are utilized to control the driving voltage of the pixel PX1; the data D5 and D4 are utilized to control the driving voltage of the pixel PX2; the data D3 and D2 are utilized to control the driving voltage of the pixel PX3; the data D1 and D0 are utilized to control the driving voltage of the pixel PX4. As shown in FIG. 6, the driving voltage outputted from the source/gate driver 424 to the corresponding pixels is determined by different output combinations of the data D7˜D0. For example, when the data D5 is logic “0” (low voltage level) and the data D4 is logic “1” (high voltage level), the source/gate driver 424 outputs the voltage V_{NEG} to the pixel PX2.

For instance, assuming the first data the pixel PX1 displays is the grey level G1 and the grey level G1 requires a period of five voltage pulses to complete. For the duration of five voltage pulses, the timing controller 421 outputs the data D7 of logic “0” (low voltage level) and the data D6 of logic “0” (low voltage level), for the source/gate driver 424 to output the positive voltage V_{POS}. Writing the grey level G1 to the pixel PX1 is completed after the period of five voltage pulses (i.e. the charged particle of the pixel PX1 has reached the position corresponding to the grey level G1 in the electrophoretic medium), and the timing controller 421 then stops outputting the data D7 of logic “0” (low voltage level) and the data D6 of logic “0” (low voltage level). Due to the erasing time is approximately equivalent to the writing time, the timing controller 421, for the duration of five voltage pulses, outputs the data D7 of logic “0” (low voltage level) and the data D6 of logic “1” (high voltage level), for the source/gate driver 424 to output the negative voltage V_{NEG}.

Therefore, the pixel PX1 is erased after the period of five voltage pulses (i.e. the charged particle is moved back to the initialization position in the electrophoretic medium), and the timing controller 421 then stops outputting the data D7 of logic “0” (low voltage level) and the data D6 of logic “1” (high voltage level). The pixel PX1 must be erased before the next grey level is written in, and in the present invention, the pixel PX1 is written by the next grey level immediately after the pixel PX1 is erased.

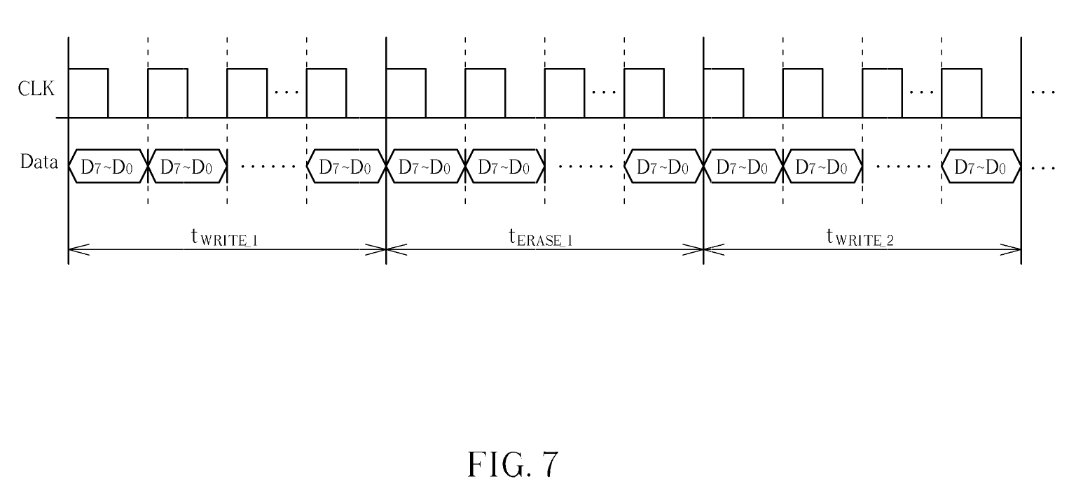

Please refer to FIG. 7. FIG. 7 is a timing diagram illustrating the timing sequence of the data D7˜D0 outputted from the timing controller 421. The duration t_{WRITE}_{_{—}}₁ represents the time required for the first grey level being written to the pixel PX1; the duration t_{ERASE}_{_{—}}₁ represents the time required for the first grey level being erased from the pixel PX1; the duration t_{WRITE}_{_{—}}₂ represents the time required for the second grey level being written to the pixel PX1. The timing controller 421 utilizes the memory 422 to store the writing data and the erasing data, so the erasing step of every pixel is independent from other pixels in a displayed frame. In other words, when erasing the first grey level from the pixel PX1 is completed, the second grey level is able to be written into the pixel PX1 immediately. Therefore, each pixel can be written by the next grey level without having to wait for all the other pixels in a displayed frame to complete the current erasing step. As a result, the erasing time required to refresh a displayed frame is reduced, subsequently improving the motion blur when the EPD device refreshes the displayed frame.

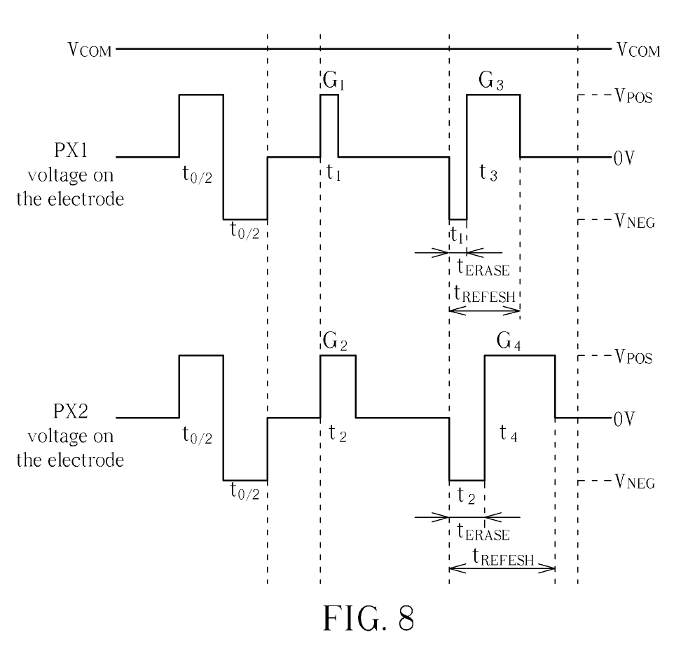

Please refer to FIG. 8. FIG. 8 is a timing diagram illustrating the driving voltages of the EPD device of the present invention. Taking the pixels PX1 and PX2 in FIG. 5 as an example, the positive voltage V_{POS} is applied to the pixels PX1 and PX2 for half the duration t0 (i.e. the duration t0/2), and the negative voltage V_{NEG} is then applied to the pixels PX1 and PX2 for the duration t0/2, for initializing the pixels PX1 and PX2. The positive voltage V_{POS} is firstly applied to the pixel PX1 for the duration t1, for writing the grey level G1 to the pixel PX1. Concurrently, the positive voltage V_{POS} is applied to the pixel PX2 for the duration t2, for writing the grey level G2 to the pixel PX2. The pixels PX1 and PX2 need to be erased before being written by the next grey levels. The time required for writing the grey level G1 to the pixel PX1 is the duration t1, so the time required for the grey level G1 being erased from the pixel PX1 is also approximately the duration t1. Similarly, the time required for writing the grey level G2 to the pixel PX2 is the duration t2, so the time required for the grey level G2 being erased from the pixel PX2 is also approximately the duration t2. Due to every pixel has a different erasing time t_{ERASE}, each pixel is written by the next grey level immediately when the corresponding erasing step is completed, for reducing the time required to refresh the displayed frame. Therefore, the grey level G3 is written to the pixel PX1 immediately after the pixel PX1 is erased. Similarly, the grey level G4 is written to the pixel PX2 immediately after the pixel PX2 is erased. Every pixel can proceed to be written by the next grey level, without having to wait for the other pixels to complete the erasing step. Therefore, the duration t_{ERASE} required to erase the grey level stored in each pixel is independent, and the duration t_{REFRESH} required to refresh a displayed frame is significantly reduced to improve the motion blur.

To conclude, the present invention provides a method for driving an EPD Device, for reducing the motion blur when a displayed frame is refreshed. The EPD device includes a plurality of pixels, wherein the first grey level is written to the first pixel and the second grey level is written to the second pixel. When the EPD device refreshes the displayed frame, the first pixel and the second pixel are erased individually. After the first pixel is erased, the third grey level is written to the first pixel immediately. After the second pixel is erased, the fourth grey level is written to the second pixel immediately. Therefore, each pixel can be written by their next grey levels without having to wait for the other pixels to complete erasing. As a result, the time required to refresh a displayed frame is significantly reduced, consequently improving the motion blur of the EPD device.

Those skilled in the art will readily observe that numerous modifications and alterations of the device and method may be made while retaining the teachings of the invention.

What is claimed is:

1. A method for driving an Electrophoretic Display (EPD) device, the method comprising:
writing a first grey level to a first pixel;
writing a second grey level to a second pixel;
erasing the first pixel;
erasing the second pixel;
after the first pixel is erased, writing a third grey level to the first pixel immediately; and
after the second pixel is erased, writing a fourth grey level to the second pixel immediately.

2. The method of claim 1, wherein writing the first grey level to the first pixel comprises applying a positive voltage to the first pixel for a first duration, and writing the second grey level to the second pixel comprises applying the positive voltage to the second pixel for a second duration.

3. The method of claim 2, wherein erasing the first pixel comprises applying a negative voltage to the first pixel for the first duration, and erasing the second pixel comprises applying the negative voltage to the second pixel for the second duration.

4. The method of claim 2, wherein the first duration is not equivalent to the second duration.

5. The method of claim 2, wherein writing the third grey level to the first pixel comprises applying the positive voltage to the first pixel for a third duration, and writing the fourth grey level to the second pixel comprises applying the positive voltage to the second pixel for a fourth duration.

6. The method of claim 1, further comprising:
providing an electrophoretic medium; and
providing a plurality of charged particles.

7. The method of claim 6, wherein writing the first grey level to the first pixel comprises driving the charged particles of the first pixel to a position in the electrophoretic medium corresponding to the first grey level, and writing the second grey level to the second pixel comprises driving the charged particles of the second pixel to a position in the electrophoretic medium corresponding to the second grey level.

8. The method of claim 6, wherein erasing the first pixel comprises driving the charged particles of the first pixel to an initial position in the electrophoretic medium, and erasing the second pixel comprises driving the charged particles of the second pixel to the initial position in the electrophoretic medium.
